(19) United States
(12) Patent Application Publication
(10) Pub. No.: US 2018/0030678 A1
(43) Pub. Date: Feb. 1, 2018

(54) STRIPING APPARATUS

(71) Applicant: Specialized Pavement Marking, Inc., Tualatin, OR (US)

(72) Inventors: Mark A. Price, Prineville, OR (US); Robert J. Busse, Lake Oswego, OR (US)

(21) Appl. No.: 15/661,265

(22) Filed: Jul. 27, 2017

Related U.S. Application Data
(60) Provisional application No. 62/369,429, filed on Aug. 1, 2016.

(51) Int. Cl. E01C 23/22; B05B 7/04; F16K 31/363; B05B 7/02

(52) U.S. Cl. CPC E01C 23/22; B05B 7/025; B05B 7/0416; F16K 31/363

(57) ABSTRACT

An apparatus for applying fluid material to a road or runway surface may be provided in which the apparatus comprises: a material distribution bar to be extended laterally and parallel but spaced from the surface, the bar having closed ends and defining a laterally-extending fluid distribution slot through which material is to be pumped; a system for providing material under pressure in a flow path; and a valve disposed between the material distribution bar and the system for providing material under pressure, to selectively open and close to control the flow of material from the system to the material distribution bar and the a fluid distribution slot.

### CROSS REFERENCE TO RELATED APPLICATIONS

The present application claims priority to U.S. Patent Application No. 62/369,429, filed Aug. 1, 2016, titled “Ribbon Gun,” the disclosure of which is hereby incorporated by reference in its entirety.

### TECHNICAL FIELD

Embodiments herein relate to the application of marking indicia to roadways and runways.

### BACKGROUND

Highway and road markings have been used for many years to guide drivers as they maneuver vehicles down the road. Examples are interrupted yellow lines between different lanes of travel, passing and no-passing zones, white side lines, pedestrian lanes, bicycle lanes, turn and no-turn lanes, and other marking indicia. Such striping is also used on airport runways to identify areas where airplanes should and should not be maneuvering, lanes to and from runways, to and from gates, and for similar uses. All of these uses are within the definition of “road marking,” “road surface” or “roadway” as used herein. Most of these markings use an aqueous traffic paint, which typically includes polymer particles containing soft and hard polymers, along with suitable solvent compositions. Various other thermoplastic materials are also used. One material that has recently been introduced is methyl methacrylate (“MMA”).

Systems for applying marking vary greatly. Many involve spray painting lines and other indicia. Such systems have worked reasonable well since they do not have to actually contact the road surface, which is not only rough and irregular but is often covered with debris. However, spray paint road marking systems sometimes have difficulty defining edges and starting and stopping points when intermittent marking is desired. In addition to issues with definition, such striping is often not thick enough to last through years of traffic, snow plowing and weather. In order to be sprayed, the paint cannot be very viscous, and this further reduces the thickness of the coatings or striping being applied.

Various thermoplastic materials have been applied to the road surface as a thick ribbon, which overcomes some of the drawbacks expressed above. However, because the material is thermoplastic, the material has to be kept hot until it hits the road surface. This requires that some sort of jacket surround the application member, which creates practical difficulties. A knife that is designed to open and close the application member and controls the flow of the thermoplastic material out of the member and onto the road surface.

MMA is an extremely durable plural component material that can be used for applying marking indicia to road surfaces. MMA is normally applied by one of two methods. A heavy “shoe” apparatus has been used, which is dragged over the road surface, with a knife being used to close off the shoe gate that distributes the MMA. MMA can also be applied using a spray process but materials may need to be removed from the MMA to make it less viscous so it can be sprayed through a spray head.

While these two systems of applying MMA to a road surface have been generally satisfactory, there are many drawbacks. Using the shoe system that contacts the road surface requires a heavy duty shoe that often gets fouled with road debris or the MMA itself, which tends to stick to anything in which it comes into contact. This requires the application process to be stopped while the shoe is cleaned. Also, because the shoe rides directly on the road surface, irregularities and unevenness in the surface results in variations in the indicia being applied and problematic wear to the shoe itself.

As noted above, spraying through a spray head requires the MMA to be thinned to reduce viscosity. This reduces the thickness and therefore the durability of the indicia. It also can result in the definition of the lines and other indicia being reduced.

The disclosed embodiments provide an apparatus is provided for applying fluid material to a road or runway surface. The apparatus includes a material distribution bar to be extended laterally and parallel but spaced from the surface, the bar having closed ends and defining a laterally-extending fluid distribution slot through which material is to be pumped; a system for providing material under pressure in a flow path; and a valve disposed between the material distribution bar and the system for providing material under pressure, to selectively open and close to control the flow of material from the system to the material distribution bar and the fluid distribution slot.

The apparatus may also include a valve control mechanism for selectively opening and closing the valve, the mechanism comprising a fluid-operated piston and cylinder arrangement (it is typically pneumatic) in which fluid under pressure is provided to displace to both open and close the valve.

The material distribution bar may be in the form of a cylindrical bar having removable caps on each end, with a conduit extending from the system for providing material under pressure in a flow path.

An apparatus for spraying fluid material onto a road or runway surface may also be provided including a spray valve having an air inlet defining an air fluid path and a material inlet defining a material fluid path, the two paths merging immediately prior to an outlet orifice, a system for providing material under pressure in a flow path, a valve disposed between the spray valve and the system for providing material under pressure to selectively open and close to control the flow of material from the system to the spray valve, and a valve control for selectively opening and closing the valve, the valve control comprising a piston/cylinder arrangement with fluid controls to positively drive the piston to both open and close the valve, and including a rod extending from the piston/cylinder arrangement to a control ball, which is selectively moved into and out of engagement with a seat to close and open the valve, respectively. The fluid may be air (pneumatic) or oil (hydraulic) although pneumatic control systems are preferred.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 is a perspective view of a first embodiment of the present invention, showing the application gun and a material distribution bar;

FIG. 2 is a side elevation view of the embodiment of FIG. 1;

FIG. 3 is a front elevation view of the embodiment of FIG. 1;

FIG. 4A is a side elevation sectional view of the embodiment of FIG. 1, with the valve in an open position, but not showing the distribution bar for simplification;

FIG. 4B is a side elevation sectional view of the embodiment of FIG. 1, with the valve in a closed position, but not showing the distribution bar for simplification;

FIG. 5 is a perspective view of a second embodiment of the present, showing the application gun and a spray nozzle;

FIG. 6 is a side elevation view of the embodiment of FIG. 5;

FIG. 7 is a front elevation view of the embodiment of FIG. 5;

FIG. 8 is a side elevation sectional view of the spray valve of the embodiment of FIG. 5;

FIG. 9 is a perspective view of the embodiment of the material distribution bar depicted in FIG. 1;

FIG. 10 is a perspective view of another embodiment of a material distribution bar; and

FIG. 11 is a perspective view of yet another embodiment of a material distribution bar.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

The depicted embodiments utilize a so-called “ribbon” application process that lays down a ribbon of striping or other indicia that can be precisely located, with clean definition to the edges, and can provide a wide variety of thicknesses, depending up the precise material being applied, the surface to which it is being applied, the durability that is required due to traffic and weather. Moreover, the depicted embodiment facilitates these advantages while being suspended over the road surface, thus eliminating many of the drawbacks with the shoe system that rides directly on the road surface; that is, the equipment does not get fouled due to road debris, can be lightweight because it will not encounter the wear associated with direct contact, and is not affected by irregularities in the road surface that can cause the shoe to be deflected, worn or cause the indicia to be applied in an unintended pattern.

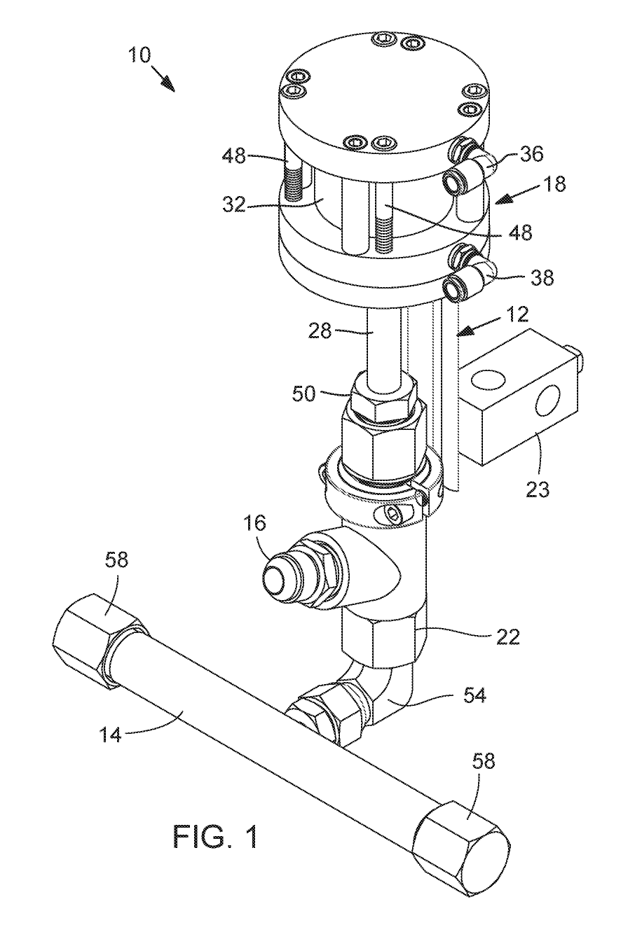

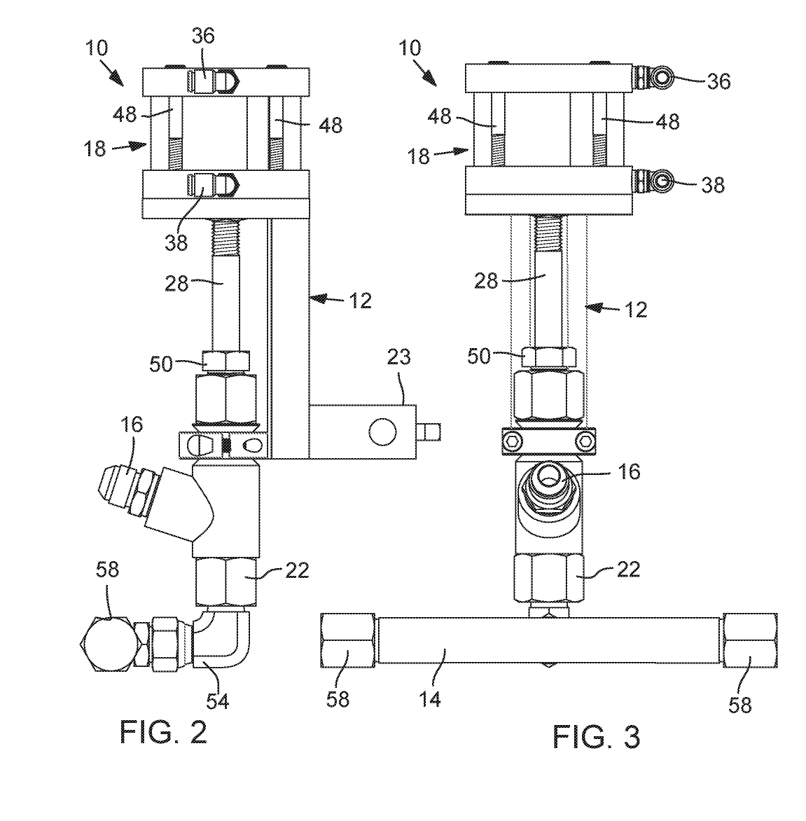

### The Embodiment of FIGS. 1-4

One form the apparatus for applying the marking indicia may take is that depicted in FIGS. 1-4. The striping apparatus is depicted generally at 10. It typically includes two portions —an application gun 12 designed to provide material for distribution under pressure, and a material distribution bar 14, which applies the material onto the roadway. The term “material” as used herein can be any type of fluid material used to apply striping or other marking indicia to roadways or runways. It might be any type of polymer or other thermoplastic material. As noted above, MMA appears to be particularly well suited for this purpose.

While it should be understood that application gun 12 and distribution bar 14 are normally used together, some applications may permit material feed systems other than application gun to supply material to the distribution bar. The term “ribbon” is used herein to describe the material being distributed through distribution bar 14. The term is particularly appropriate when used with the depicted apparatus 10 because it can be laid down in an extremely viscous and thick layer of indicia that readily applies itself to even a somewhat irregular road surface but also will be extremely durable due to the thickness of the ribbon.

Application gun 12 is designed to provide MMA or other striping material under pressure to distribution bar 14. Actually, striping material is typically provided to the application gun at the desired pressure, with the striping material already mixed and ready to be applied to the road surface. The equipment for doing that is conventional in design and therefore has not been depicted and will not be described.

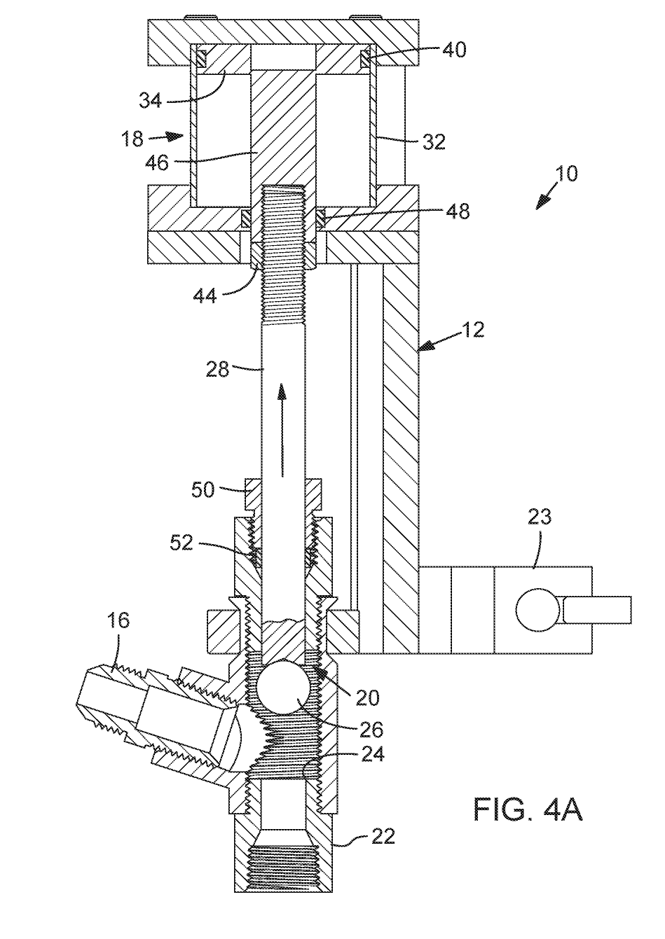

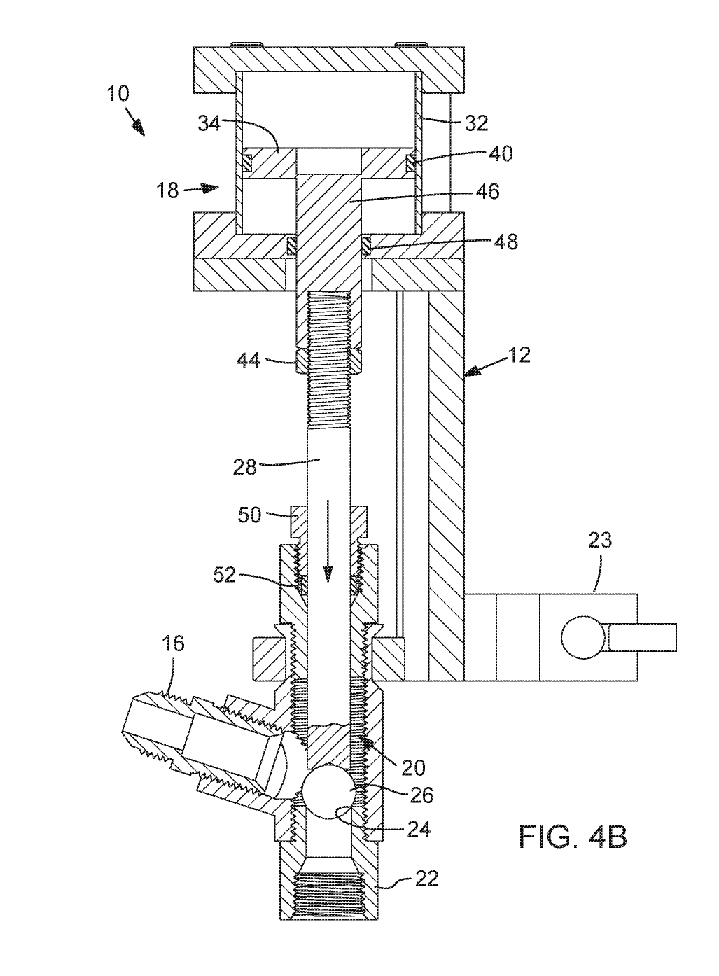

Application gun 12 may include an intake nipple 16, a valve drive cylinder 18, a valve 20 (See FIGS. 4A and B), and a gun discharge end 22. Intake nipple 16 is connected to a system for mixing and supplying MMA or other material, and provides that material under pressure to valve 20. Since the material is being directed downward toward gun discharge end 22, intake nipple 16 may be disposed at an oblique angle with respect to valve 20. It may be threaded into place or mounted in some other removable fashion so it may be removed from valve 20 for cleaning or replacement. A block 23 may be provided on the side of application gun 12 to mount the gun to adjacent structure on a vehicle carriage (not shown).

Valve 20 may include a valve seat 24 which is designed to receive a ball valve 26 as shown best in FIG. 4B in its seated position. Ball valve 26 is typically mounted to a valve control rod 28, which extends between the ball valve and a valve control mechanism, which may include a cylinder 32 (See FIGS. 4A and B). As the name suggests, the valve control mechanism controls the position of valve 26, causing it to open upwardly to the position depicted in FIG. 4A when MMA or other material is intended to be pumped from intake nipple 16 to discharge end 22, and close downwardly against valve seat 24 to the position in FIG. 4B when the flow of material is to be stopped.

Cylinder 32 may have a reciprocable piston 34 therein (See FIGS. 4A and B), the position of which is controlled by two pneumatic lines with connections 36 and 38, shown in FIGS. 1-3. It can be seen that piston 34 acts as a double-acting piston with air being pumped into or drawn from the top or bottom of cylinder 32, depending upon the desired position of ball valve 26. This positive force on the top or bottom of piston 34 ensures that ball valve 26 will be positively driven into the desired position even if viscous MMA or other material is disposed in valve 26. As shown best in FIGS. 4A and 4B, appropriate air seals 40 and 42 are included adjacent piston 34 and valve control rod 28, respectively, to minimize air leakage during the operation of piston.

One of the advantages of apparatus 10 is that striping material does not need to be applied using compressed air. This may eliminate the need for a large compressor being mounted to the application vehicle. Given that piston 34 can be operated using a small amount of air, a small compressed air bottle may be used on the vehicle instead of having a large air compressor.

A lock nut 44 may be included to fix the position of valve control rod 28 with respect to a piston rod 46, and evenly spaced head bolts 48 may be provided to maintain the integrity of cylinder 32 in conventional fashion.

Where valve control rod 28 enters valve 20, a threaded seal bushing 50 secures a seal 52 in place against a threaded valve bushing 54 to minimize leakage of MMA or other material from the valve.

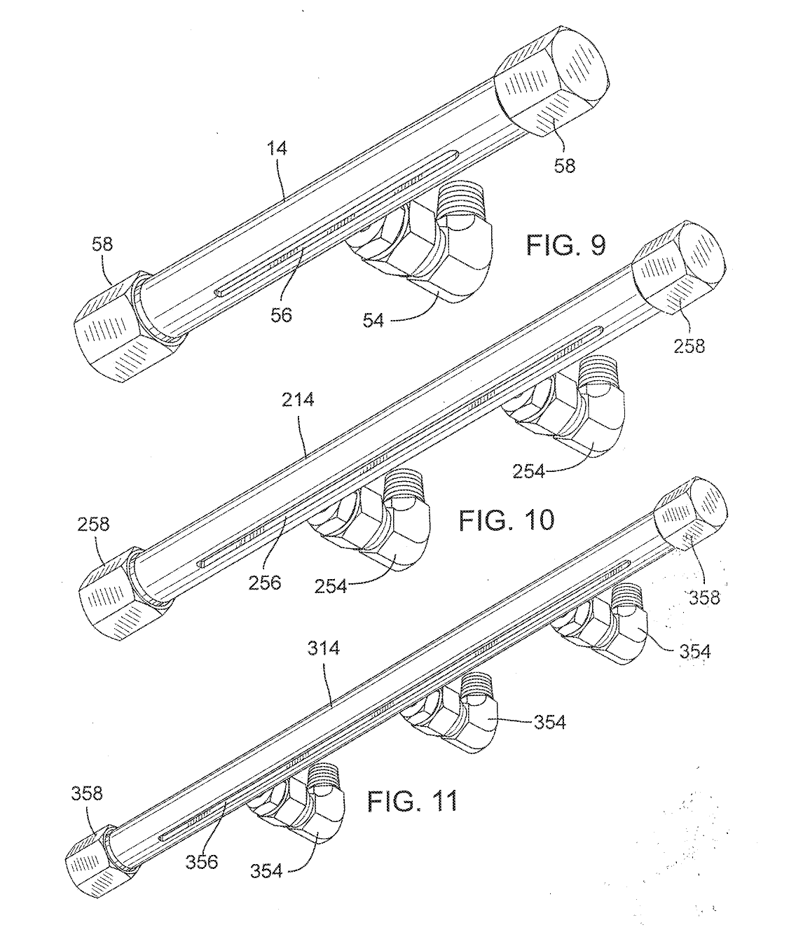

As shown in FIGS. 1-3 and 9, material distribution bar 14 is mounted via a bar nipple 54 to gun discharge end 22 to receive MMA or other material from application gun 12 and distribute it in a ribbon onto the roadway or other surface. A fluid distribution slot 56 extending much of the length of distribution bar 14 is provided at the bottom of the bar to distribute material in the desired pattern. The slot is designed to extend laterally with respect to the roadway or other surface, or perhaps better expressed, laterally to the direction of travel of the vehicle with which apparatus 10 is moving across the surface. In normal usage, it will be spaced from the surface by a distance that depends on the material being applied, the form the indicia are to take, the undulations and other variations in the surface, and other factors. This spacing might be in the range of one to several inches.

A cap 58 is provided at each end of distribution bar 14. Caps 58 may be threaded so they can be removed for periodic cleaning. In certain applications it may be desirable to pack grease into the ends of bar 14 prior to mounting a pair of grease caps 58 to minimize the likelihood of material hardening onto them. Slot 56 may be a wide variety of dimensions, depending on the application, the conditions, and the material being distributed but it has been found that, with a bar inner diameter of 1 inch, a slot that is ⅛ or ¼ inch wide and 4 inches long is suitable, although the slot 56 may be 12 inches long or longer, depending on the width of the desired stripe.

There are many advantages with the use of the apparatus 10, some or all of which may be achieved, depending on the application conditions and the components actually selected. First and foremost, there is nothing in the system that needs to touch the surface being striped. This facilitates a smooth, consistent ribbon of material to be applied to the road or other surface. Deviations, contours or rough surfaces do not affect the quality of the stripe or other marking indicia. As mentioned above, apparatus 10 does not require air to move striping material through the apparatus. With no need for air, equipment costs are less, as vehicle-mounted compressors are no longer over-worked, saving maintenance and fuel costs. Unlike a spray application, there is little problem with definition at the edges of the indicia because air is not used to drive the material through.

Because distribution bar 14 does not contact the surface to which the material is being applied, apparatus 10 will rarely need to be stopped for cleaning. In the event distribution bar 14 does become fouled, it can be quickly and easily replaced, or it can be easily cleaned by removing caps 58. The cleaning of shoes larger amounts of solvent, which can be a hazardous material, requiring troublesome and sometimes expensive disposal.

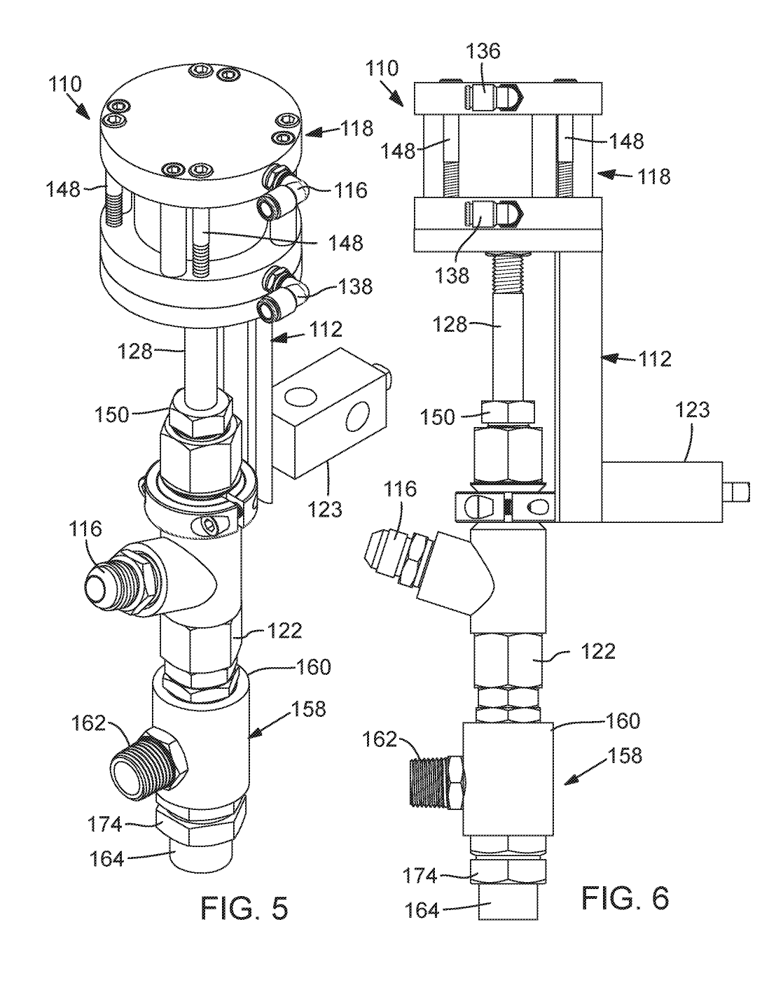

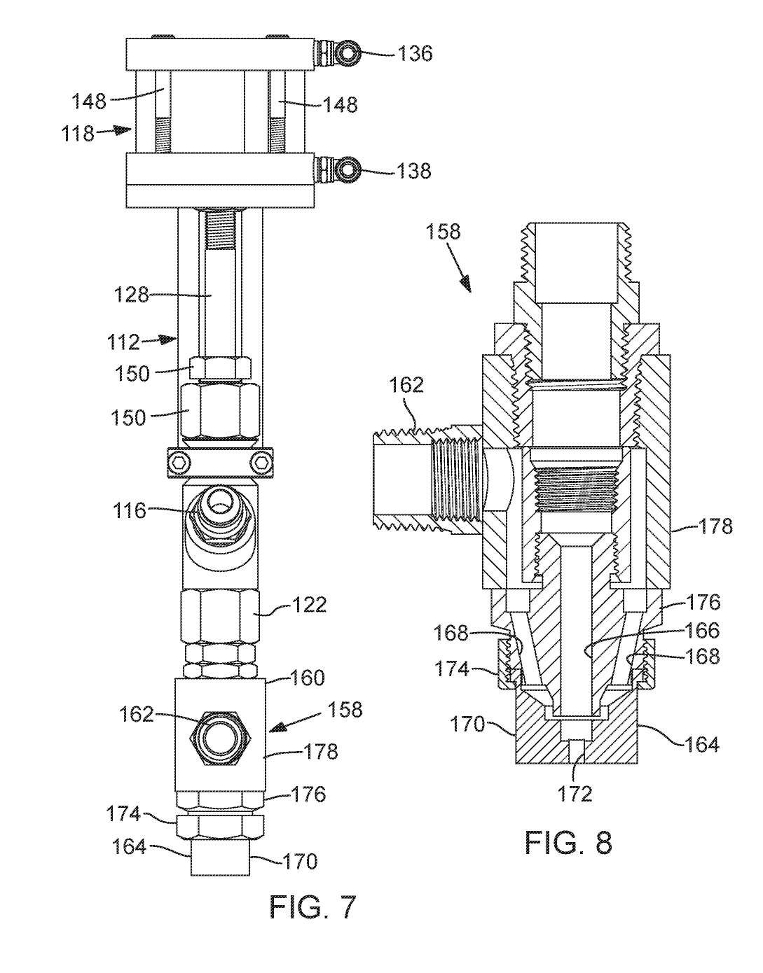

### The Embodiment of FIGS. 5-8

The embodiment of FIGS. 5-8 may be the same as that of FIGS. 1-4 other than the replacement of the distribution bar with a spray nozzle 158. While there are many advantages in using apparatus 10 with distribution bar 14, in some applications it may be desirable to use an application gun like that shown at 10 in combination with a spray head instead of a distribution bar. In this second embodiment, the principal parts of the application gun have been identified with numerals corresponding to the embodiment of FIGS. 1-4, except that they are in the 100 series. The apparatus has thus been identified at 110, the application gun at 112, the intake nipple at 116, the valve drive cylinder at 118, the valve at 120, and the gun discharge end at 122.

As best shown in FIG. 8, spray nozzle 158 includes a material intake end 160, an air intake 162 and a spray outlet 164. The material is pumped into material intake end 160 and passes through a centrally-disposed material channel 166 toward spray outlet 164. Immediately prior to reaching the spray outlet, the material is subjected to pressurized air that is pumped through air intake 162 to a series of evenly-spaced air channels 168 that mix with the material and spray it out spray outlet 164.

To facilitate cleaning of spray nozzle 158, the spray nozzle may be formed of several different pieces that are removably fastened to each other, such as by threads. A spray tip 170 including a spray orifice 172 may be mounted at the very end. Replacement of spray tip 170 with tips having larger or smaller orifices is thus possible, which may be an advantage to facilitate apparatus 110 being used for different materials, different indicia requirements, and different operating conditions.

In the depicted embodiment, spray tip 170 is not threaded to the rest of spray nozzle 158 but instead is secured in place by a collar 174 that is threaded to a spray nozzle adaptor 176, which is in turn threaded to a pipe coupler 178. Pipe couple 178 may be detachably mounted, such as by threading, to other members, the top member of which is detachably mounted, such as by threading, to gun discharge end 122.

### The Embodiments of FIGS. 10 and 11

The embodiments of FIGS. 10 and 11 are simply different embodiments of the material distribution bar 14, which include two or three bar nipples, here 254 and 354, which may be removably mounted, such as by threading. These embodiments of the distribution bar, identified at 214 and 314, respectively, may in all other respects be the same as the embodiment of FIGS. 1-4 but may be desirable in the event wider material ribbons need to be spread onto the roadway or other surface. Each of these embodiments include a slot 256 or 356 through which material in the form of a ribbon is designed to pass. While the precise dimensions of slots 256 and 356 may vary, again, depending on the application, the conditions, and the material being distributed but it has been found that with a bar inner diameter of 1 inch, a slot that is ¼ inch wide and 7 inches long, and ¼ inch wide and 8.5 inches wide, respectively, is suitable (or whatever the width of the desired stripe would be). Like distribution bar 14, distribution bars 214 and 314 may include threaded caps 258 and 358, respectively.

The disclosure set forth above may encompass multiple distinct inventions with independent utility. While each of these inventions has been disclosed in its preferred form, the specific embodiments thereof as disclosed and illustrated herein are not to be considered in a limiting sense, as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

What is claimed is:

1. An apparatus for applying fluid material to a road or runway surface, comprising:
a material distribution bar to be extended laterally and parallel to but spaced from the surface, the bar having closed ends and defining a laterally-extending fluid distribution slot through which material is to be pumped;
a system for providing material under pressure in a flow path; and
a valve disposed between the material distribution bar and the system for providing material under pressure, to selectively open and close to control the flow of material from the system to the material distribution bar and the fluid distribution slot.

2. The apparatus of claim 1 further comprising a valve control mechanism for selectively opening and closing the valve, the mechanism comprising a fluid-operated piston and cylinder arrangement in which fluid under pressure is provided to both open and close the valve.

3. The apparatus of claim 2 wherein the fluid for operating the piston and cylinder arrangement is air.

4. The apparatus of claim 1 wherein the material distribution bar comprises a cylindrical bar having removable caps on each end, with a conduit extending from the system for providing material under pressure in a flow path.

5. An apparatus for spraying fluid material onto a road or runway surface, comprising:
a spray valve having an air inlet defining an air fluid path and a material inlet defining a material fluid path, the two paths merging immediately prior to an outlet orifice;
a system for providing material under pressure in a flow path;
a valve disposed between the spray valve and the system for providing material under pressure, to selectively open and close to control the flow of material from the system to the spray valve; and
a valve control for selectively opening and closing the valve, the valve control comprising a piston/cylinder arrangement with fluid controls to positively drive the piston to both open and close the valve, and including a rod extending from the piston/cylinder arrangement to a control ball, which is selectively moved into and out of engagement with a seat to close and open the valve, respectively.
